(19) United States
(12) Patent Application Publication
(10) Pub. No.: US 2015/0288734 A1
(43) Pub. Date: Oct. 8, 2015

(54) ADAPTIVE LEVERAGING OF NETWORK INFORMATION

(71) Applicant: NOKIA SIEMENS NETWORKS OY, Espoo (FI)

(72) Inventors: John Harris, Glenview, IL (US); Ronald Crocker, St. Charles, IL (US)

(21) Appl. No.: 14/441,699

(22) PCT Filed: Nov. 9, 2012
(86) PCT No.: PCT/US12/64361

§ 371 Date: May 8, 2015

(51) Int. Cl. H04L 29/06; H04L 29/08

(52) U.S. Cl. CPC H04L 65/602; H04L 65/4069; H04L 67/02

(57) ABSTRACT

Various communication systems may benefit from adaptive leveraging of network information. For example, cellular optimization may be accomplished by selective use of a web technique by applications on network devices. A method may include sending, from a user equipment device or application server, a signal configured to identify a need for network information. The method may also include receiving the network information in response to the signal. The method may further include adapting a session with an application based on the network information.

### BACKGROUND

1. Field

Various communication systems may benefit from adaptive leveraging of network information. For example, cellular optimization may be accomplished by selective use of a web technique by applications on network devices.

2. Description of the Related Art

A media optimizer in the core network cannot cause certain streaming applications to perform certain adaptations that are solely controlled by the application in the client. This may be true, for example, for adaptation of whether to prefill or only download video just in time where within these protocols the next section of video can only be downloaded when the user equipment (UE) App/application sends a requested uniform resource locator (URL) corresponding to the next section of video. A browsing gateway is one example of a media optimizer. Some media optimizers may sit outside of the evolved packet core (EPC).

In certain conventional approaches, radio information is conveyed up to a media optimizer within the network. However, a media optimizer in the network may be unable perform certain adaptations, as explained above.

### SUMMARY

According to a first embodiment, a method includes sending, from a user equipment device or application server, a application level signal configured to identify a need for network based information to an information server. The method also includes receiving the network based information based response in response to the signal. The method further includes adapting a session with a second application server based on the network based information received from the information server.

According to a second embodiment, a method includes receiving, from a user equipment device or application server, an application level signal configured to identify a need for network information. The method also includes providing the network based information in response to the application level signal.

In a third embodiment, an apparatus includes at least one processor and at least one memory including computer program code. The at least one memory and the computer program code are configured to, with the at least one processor, cause the apparatus at least to send, from a user equipment device or application server, a application level signal configured to identify a need for network based information to an information server. The at least one memory and the computer program code are also configured to, with the at least one processor, cause the apparatus at least to receive the network based information based response in response to the signal. The at least one memory and the computer program code are further configured to, with the at least one processor, cause the apparatus at least to adapt a session with a second application server based on the network based information received from the information server.

In a fourth embodiment, an apparatus includes at least one processor and at least one memory including computer program code. The at least one memory and the computer program code are configured to, with the at least one processor, cause the apparatus at least to receive, from a user equipment device or application server, an application level signal configured to identify a need for network information. The at least one memory and the computer program code are also configured to, with the at least one processor, cause the apparatus at least to provide the network based information in response to the application level signal.

In a fifth embodiment, an apparatus includes sending means for sending, from a user equipment device or application server, a application level signal configured to identify a need for network based information to an information server. The apparatus also includes receiving means for receiving the network based information based response in response to the signal. The apparatus further includes adapting means for adapting a session with a second application server based on the network based information received from the information server.

In a sixth embodiment, an apparatus includes receiving means for receiving, from a user equipment device or application server, an application level signal configured to identify a need for network information. The apparatus also includes providing means for providing the network based information in response to the application level signal.

According to seventh and eighth embodiments, a non-transitory computer-readable medium encoded with instructions that, when executed in hardware, performs a process. The process respectively includes the method according to the first and second embodiments.

According to a ninth embodiment, a system includes a first apparatus comprising sending means for sending, from a user equipment device or application server, a application level signal configured to identify a need for network based information to an information server, receiving means for receiving the network based information based response in response to the signal, and adapting means for adapting a session with a second application server based on the network based information received from the information server. The system also includes a second apparatus comprising receiving means for receiving, from the user equipment device or application server, the application level signal configured to identify a need for network information and providing means for providing the network based information in response to the application level signal.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a simplified architecture according to certain embodiments.

FIG. 3 illustrates another method according to certain embodiments.

FIG. 4 illustrates a system according to certain embodiments.

FIG. 5 illustrates a system and proxy architecture according to certain embodiments.

### DETAILED DESCRIPTION

A number of significant system capacity, user experience, operator profitability improvements may be achieved when an application becomes aware of a specific radio frequency (RF) events. Certain embodiments, therefore, provide mechanisms for enabling conveying the evolved Node B (eNB) radio event information to the application, particularly, for example, in the case of a client-dominated application.

A client-dominated application may be one in which application interactions are predominantly initiated and terminated by the client. Such applications may be characterized by the client's periodical requests for information from the server via a pull request. Examples of such clients include mail, adaptive streaming video, social media, and certain news and financial applications. Many smartphone applications may be client-dominated applications.

Client-dominated applications may largely be immune to classic optimization. For example, actions may not be able to be triggered earlier, or entirely prevented, where optimizations affect transfers only after they have been initiated. Likewise, actions cannot be modified, where optimizations take effect post action.

In certain embodiments, the server may not be literally providing radio information, but rather may be providing radio network status based specific suggestions or commands to the client. For example, the radio information, specific suggestions, or specific commands may be customized or tailored to that particular application.

In many cases conveying eNB radio event (based) information (or commands/suggestions) to the application in the UE may benefit both the operator and the user. For example, in the case of video downloading, one way to enhance user experience is to allow prefill. Prefill can involve buffering downloaded content at the user's end to hide temporary transmission hiccups. However, since it is very usual to quit viewing before the video ends, all or much of the buffered unseen content may be wasted. For example, transmission capacity may be wasted and the operator and other users of overloaded cells may be impacted.

Thus, certain optimizers (such as, for example, a browsing gateway optimizer) and video clients may not allow prefill. In this case, however, a user may experience slower downloading speed or inconsistent playout (for example, glitches in the viewed video) due to varying network conditions.

Various techniques may be used to convey radio information up to a media optimizer within the network. However, there can be certain adaptations that are solely controlled by the application in the client or by an application server to which the client is connected.

Furthermore, tunneling such “suggestions” through the air interface signaling may require wireless standards changes, and may further require customized interfaces between the application and the underlying wireless functionality within the handset. The beauty of this approach is that the application developer can enable these use cases solely at the application level.

It may be advantageous for both the user and the operator if the client application had direct information (based) on radio conditions. For example, with such information the application could allow prefilling only in underutilized eNBs.

Furthermore, better knowledge of content/application can permit better adaptation of radio and core network. Moreover, network knowledge may permit better adaptation of content and content delivery. Indeed, such a system can improve user quality of experience (QoE) and enable differentiated service for over the top (OTT) traffic.

In certain embodiments, a network can perform additional adaptations based on application knowledge gleaned through the extensions appended at the end of the URL request. However, such features are not required in all embodiments.

More particularly, certain embodiments may be configured to determine whether eNB radio resources are being wasted. If so, the embodiments may allow prefilling. On the other hand, if eNB radio resources are not being wasted, certain embodiments may prevent prefilling.

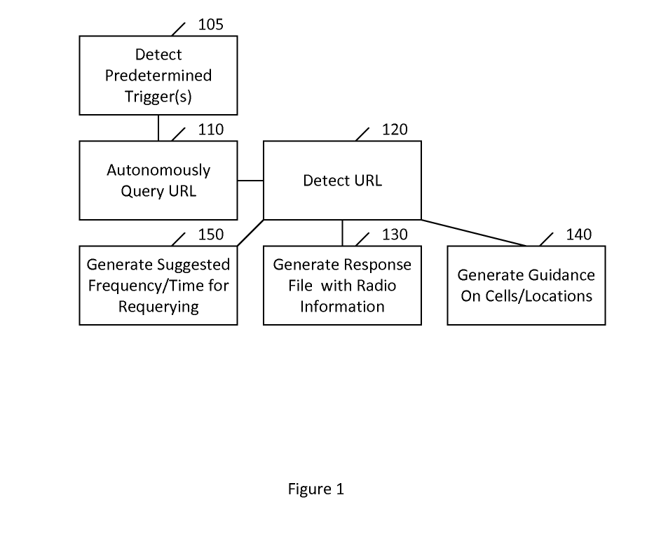

FIG. 1 illustrates a method according to certain embodiments. As shown in FIG. 1, at 110, a user equipment (UE) application autonomously can query a particular HTTP URL. This may be responsive to detecting, at 105, one or more predetermined triggers. For example, a trigger may be that an adaptive video session is initiated/ongoing. The URL sent from the user equipment may be a special URL request sent over the air. For example, this “special” URL may have been designated by LTE-A air as being the URL for retrieving network knowledge/suggestions.

When the network element, for example, a browsing gateway, media optimizer, or packet data network (PDN) gateway, detects, at 120, the transmission of this URL query from UE, that network element may locally generate, at 130, a response file based on the eNB/network radio information corresponding to the eNB and/or radio information for that client/eNB. The network element may also, at 140, generate and include, in the file or separately, guidance on which cells/locations support this feature. Moreover, the network element may also, at 150, generate and include, in the file or separately, a suggested frequency or time for the UE to re-query this URL, a time stamp of the file, or other time information that the user equipment can use to determine when to re-query.

Furthermore, this mechanism may enable greater coordination among the applications on the client device, with respect to the timing of each application initiating communication with the network. The network can observe the periodic timing of application connections from that client, and can therefore provide feedback on the timing of these communications to the other applications running on the same UE. In some cases each individual application may be unaware of the timing of periodic application connections to the network, resulting in network inefficiencies. This feedback can enable applications on the same UE to better align the timing up periodic communications with that is initiated by other applications on the same UE. Thus, certain embodiments may save network resources consumed when disjoint/non-synchronized radio communications occur. In an alternate embodiment, the URL query from each application may convey information on the time interval(s) when that specific application can indicate to the network. Thus, certain embodiments can provide this network loading information back to each individual application on the UE.

The file from the network element may be a populated extensible markup language (XML) file with eNB/network condition information. Other file types, such as JavaScript object notation (JSON) may also be used in certain embodiments. Other ways of transferring the data, such as in a short message service (SMS) message.

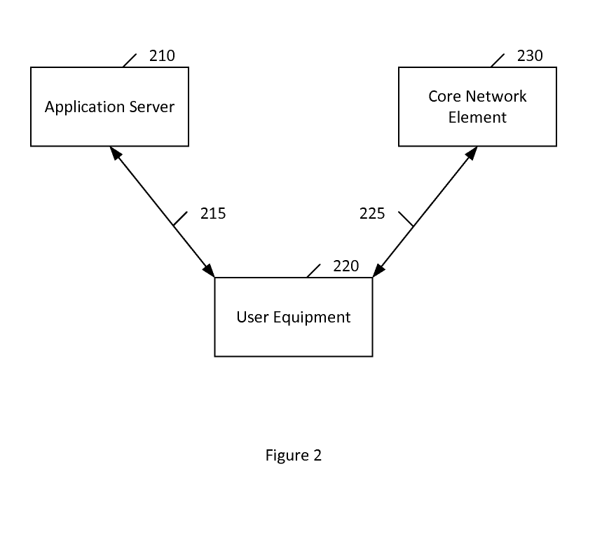

Hence, optimization may become a three-way deal among the client application in the UE, the application server, and the browsing gateway/media optimizer. FIG. 2 illustrates a simplified architecture according to certain embodiments.

FIG. 2 in particular illustrates an application server 210, a user equipment 220, and a core network element 230. The application server 210 may be the server corresponding to an application on the user equipment 220. For example, the application server 210 can be a server of a social media platform, a mail server, a gaming server, or a streaming media server, such as a streaming video server.

The user equipment 220 may be a terminal device, such as a mobile phone, a cell phone, a smartphone, a personal digital assistant (PDA), a tablet, a laptop, a mail client device, or the like. It is not required that the user equipment 220 be a mobile device. For example, the user equipment 220 may be a smart meter or sensor, which is in a fixed location for an extended period of time.

The core network element 230 may be an optimizer, such as a browsing gateway. Other core network elements can be used. The core network element 230 may have connections, not shown, to other core network and access network elements. The core network element 230 may also have connections to a public network, such as the Internet.

The application server 210 may be connected to the user equipment 220 over a first interface 215. The user equipment 220 may be connected to the core network element 230 over a second interface 225. The first interface 215 and second interface 225 are shown as separate, because there is no need for there to be any commonality to these communication paths. However, in practice parts of the communication path may be the same. For example, both interfaces may pass through a local base station, such as an eNode B. Indeed, in certain embodiments the communications to the application server 210 may pass through the core network element 230.

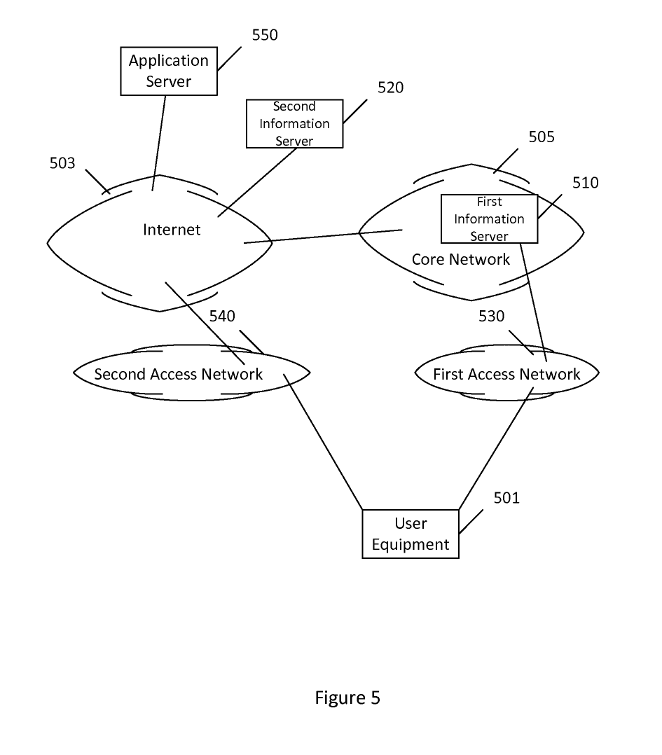

The functionality of core network element 230 may actually be distributed into two different physical elements. FIG. 5 illustrates a system and proxy architecture according to certain embodiments.

As shown in FIG. 5, there may be two information servers. A first information server 510, may be in a core network 505. The first information server 510 may be a proxy. A second information server 520 may be a server, which resides on the general Internet 503.

It should be noted that multiple networks are shown, include a first access network 530, a second access network 540, as well as the Internet 503 and the Core Network 505.

The first information server 510 can proxy the internet protocol (IP) address of the public instance of the information server, such that when a user equipment moves between a WiFi (for example, first access network 530) and cellular network (for example, second access network 540), the IP address of the information server still works and the user equipment 501 does not end up with either an unreachable addresses or an inability to reach the private instance of the information server, without having to invalidate the domain name server (DNS) cache of the UE 501. The first information server 510 and the second information server 520 can each be distinct from the application server 550.

In FIG. 5, at least the first access network 530 and at least a first core network 505 can be a cellular network with an internal InfoServer, first information server 510, inside that core network 505. At least a second access network 540 may be any other network, WiFi, roaming network, or any other network. However, this network may not have an internal InfoServer.

An at least first instance of the InfoServer can be a public InfoServer, such as the one that represents the public DNS entry for InfoServer.org or whatever it is, which can be second information sever 520. Meanwhile, an at least first address of the public InfoServer can be the IP address of the above public InfoServer as known in that DNS entry.

Furthermore, an at least second instance of the Infoserver can be a private InfoServer residing inside the core network 505 of the cellular network, such as first information server 510.

The application server 550 can be whatever application server provides an application service to the user equipment 501.

Thus, various embodiments are possible, for example, the UE 501 may be connected to at least one of an at least first access network 530 and at least second access network 540. The UE 501 may know an at least first address of an at least first instance of the InfoServer, namely second information sever 520. Moreover, the first access network 510 may be operably coupled to an at least first core network 505. The at least first core network 505 may be operably coupled to an application server 550. The at least first core network 505 may contain an at least second instance of the InfoServer, namely first information server 510.

The second access network 540 may be operably coupled to the at least first instance of the InfoServer. The second access network 540 may be operably coupled to the application server 550. Sending, from a user equipment device 501 or application server 550, may further include sending to the at least first address of the at least first instance of the InfoServer.

When the UE is connected to the at least first access network 530, the at least second instance of the InfoServer may receive the application-level signal from the UE, via the at least first access network 530 and at least first core network 505. When the UE is connected to the at least second access network 540, the at least first instance of the InfoServer may receive the application-level signal from the UE via the second access network 540 and the Internet 503.

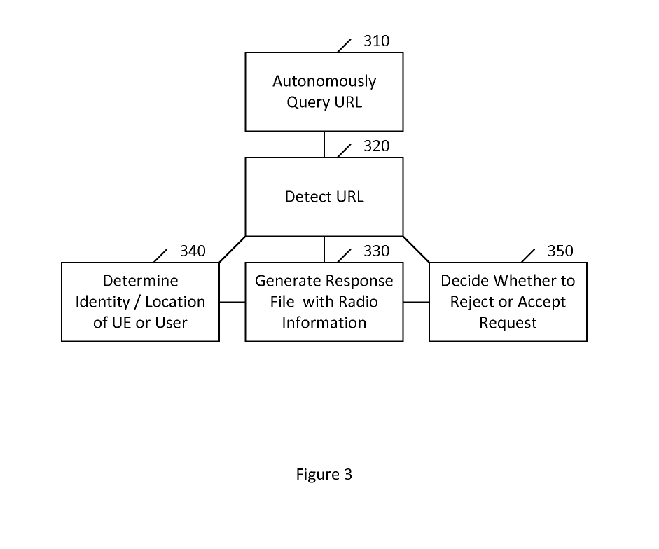

FIG. 3 illustrates another method according to certain embodiments. The method can be a method for enabling a UE application to retrieve network/radio condition information, such as information about a eNode B.

The method can include, at 310, the UE application autonomously querying a particular HTTP URL upon certain predetermined triggers. The predetermined triggers may be, for example, when an adaptive video session is initiated or ongoing.

When the network element, for example, the browsing gateway, media optimizer or PDN gateway, detects, at 320, the reception of this URL query from UE, that network element can perform various actions.

The network element may, for example, at 330 locally generate a response file containing the eNB network/radio information corresponding to the eNB/radio information for that client/eNB. The response file may be XML formatted or JSON formatted. Other formats are also permitted.

The network element may be inside the EPC. Thus, the URL request may not actually get sent out of the EPC onto the general Internet. Alternatively, the network element may be a server located on the Internet or another public network.

The response can include cached content of eNB/network information and can be dynamically generated on a per UE or eNB basis, based on a determination of an identity or location of a user equipment or user. For example, a subscriber identity can determine how much information is provided, as well as what kind of information to provide. The location of the user equipment can be an identity of a eNB that is serving the user equipment. Alternatively, the location may be a set of geographic coordinates.

If the UE is under a EPC that does not practice certain embodiments described herein, then the URL class may pass through the PDN, into the general Internet. A server on the general Internet then receives a request for that particular HTTP URL, for which the server can then decide, at 350, whether to reject the request or respond with information helping the UE to know when and where are the networks which do support the smart functionality.

The server can provide eNB network information based on the eNB network information that is available at the centralized HTTP URL server, if that information is available at the centralized server. This information may be available at the centralized server as it may be obtained through various direct APIs between this centralized server and the EPCs, or it may otherwise be obtained by monitoring application level reports from other UEs.

Furthermore, this technique can additionally apply to Wi-Fi networks. If the client/application generates a URL request while under a Wi-Fi network utilizing certain embodiments, then the same methodology may apply.

In certain embodiments, the UE may be attached to an application server and the application server may send an HTTP URL request for radio information/suggestions corresponding to the client/UE. For example, the application server may query the special URL with an extension at the end of the URL address which can comprise the UE's IP address. This request can then be intercepted by a browsing gateway. At that point, the browsing gateway can respond on the UE's behalf with the XML, JSON, or other format radio information.

The radio conditions provided may include physical resource block (PRB) utilization.

A number of significant system capacity, user experience, operator profitability improvements may be achieved when the application on the user equipment becomes aware of a specific radio frequency (RF) events. For example, in certain cases the number of billable physical resource blocks may increase.

Certain embodiments provide a mechanism for enabling conveying eNB radio event information to an application in a user equipment. The UE application may autonomously query a particular HTTP URL upon certain predetermined triggers, such as when an adaptive video session is initiated/ongoing. When the network element, such as a browsing gateway, media optimizer, or packet data network (PDN) gateway detects the reception of this URL query from UE, that network element may locally generate a response file containing the eNB network/radio information corresponding to the eNB/radio information for that client/eNB.

Certain embodiment may enable an application to have direct access to radio information so that they can perform more efficiently, without the need to perform actual hosting of application code or a fully featured media optimizer within the eNB.

Certain embodiments may be used in combination with other approaches to limiting or controlling prefilling. For example, with respect to certain application, prefilling and other bandwidth intensive features may be controlled by these commands using a client at the user equipment, whereas for other applications the prefilling, prefetching, or the like may be controlled in the network, such as at a browsing gateway.

Certain embodiments may, for example, provide various benefits, such as avoiding repeat transfers of data, such as video data, by reducing the amount of variability in the wireless link speed.

Certain embodiments may provide a way of conveying eNB/network condition information down to the UE without impacting long term evolution (LTE) protocols to convey the URL. Likewise, certain embodiments may involve modifications of LTE protocols and may work in combination with modifications to LTE protocols.

The radio information at the core network element may be radio information about the core network or about the access/edge network, or any combination thereof. In general, base station metrics, such as eNB metrics, may be provided to a browsing gateway.

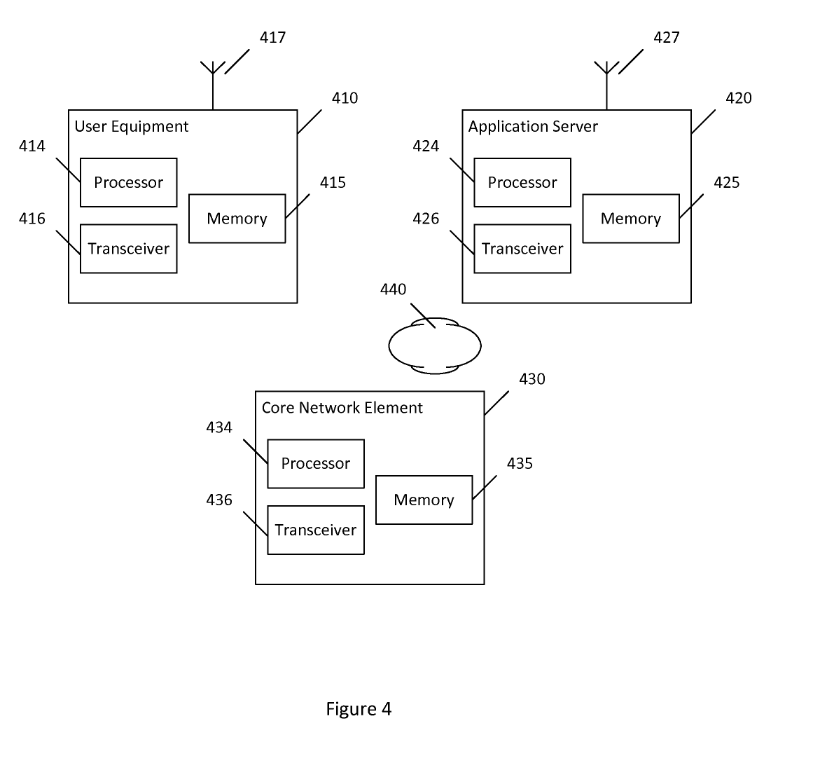

FIG. 4 illustrates a system according to certain embodiments of the invention. In one embodiment, a system may comprise several devices, such as, for example, user equipment 410, application server 420, and core network element 430. The system may comprise more than one application server, core network element, and user equipment, although only one of each is shown for the purposes of illustration.

Each of the devices in the system may comprise at least one processor, respectively indicated as 414, 424, and 434. At least one memory may be provided in each device, and indicated as 415, 425, and 435, respectively. The memory may comprise computer program instructions or computer code contained therein. One or more transceiver 416, 426, and 436 may be provided, and each device may also comprise an antenna, respectively illustrated as 417 and 427. Although only one antenna each is shown, many antennas and multiple antenna elements may be provided to each of the devices. Other configurations of these devices, for example, may be provided. For example, application server 420 may be additionally or solely configured for wired communication, and in such a case antenna 427 may illustrate any form of communication hardware, without being limited to merely an antenna. For example, the core network element 430 may be connected to the application server 420 via an internet cloud 440, which may be a wired connection.

Transceivers 416, 426, and 436 may each, independently, be a transmitter, a receiver, or both a transmitter and a receiver, or a unit or device that may be configured both for transmission and reception.

Processors 414, 424, and 434 may be embodied by any computational or data processing device, such as a central processing unit (CPU), application specific integrated circuit (ASIC), or comparable device. The processors may be implemented as a single controller, or a plurality of controllers or processors.

Memories 415, 425, and 435 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors may be any suitable form of computer program code, for example, a compiled or interpreted computer program written in any suitable programming language.

The memory and the computer program instructions may be configured, with the processor for the particular device, to cause a hardware apparatus such as user equipment 410, application server 420, and core network element 430, to perform any of the processes described above (see, for example, FIGS. 1 and 3). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

In certain embodiments, a URL address for applications to obtain radio network condition information can be publicized. Thus, individual application developers can know how to request the network conditions. Moreover, the format of the response can also be publically disclosed and/or standardized, so that the applications can easily process the responses.

The URL address may standardized across all vendors. The format of the response likewise can be standardized across all vendors. In the absence of such standardization, the UE may attempt to use a plurality of different URLs in order to determine which one will work. Furthermore, the application may be configured to automatically use a different URL in different contexts, for example, based on the operator or public land mobile network (PLMN) ID.

Furthermore, in certain embodiments, competing radio access and core networks may provide metrics of their networks to a third party server that can respond to the URL queries.

In certain embodiments, the application may have direct access to radio information so that the application can perform more efficiently, without the need to perform actual hosting of application code within the eNB.

Although, the techniques above have been described with respect to an LTE system, the techniques may also be applicable to a variety of technologies including Wi-Fi.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1.-60. (canceled)

61. A method, comprising:
sending, from a user equipment device or application server, an application level signal configured to identify a need for network based information to an information server;
receiving the network based information based response in response to the signal; and
adapting a session with a second application server based on the network based information received from the information server.

62. The method of claim 61, wherein the network based information from the first server is automatically adapted to correspond to network conditions corresponding to the user equipment, based on the information server's knowledge of a wireless communication channel corresponding to the user equipment.

63. The method of claim 61, further comprising:
configuring the application level signal to indicate at least one of an application or an application functionality.

64. The method of claim 61, wherein the sending comprises autonomously sending the application level signal as a query to a core network element.

65. The method of claim 61, further comprising:
detecting a predetermined condition, wherein the sending is responsive to the predetermined condition.

66. The method of claim 65, wherein the predetermined condition is a start of an adaptive video session to the second application server.

67. The method of claim 61, wherein the network information comprises at least one of core network information, radio access network information, or application optimization suggestion.

68. A method, comprising:
receiving, from a user equipment device or application server, an application level signal configured to identify a need for network information; and
providing the network based information in response to the application level signal.

69. The method of claim 68, further comprising:
identifying a location of the user equipment based on the wireless communication channel over which the application level signal was received, wherein the providing the network information is based on the location.

70. The method of claim 68, wherein the providing the network based information comprises providing core network information, radio access network information, or periodic UE network connection information.

71. The method of claim 68, further comprising:
determining whether to reject or respond to the signal, wherein the signal is received over a public network.

72. The method of claim 68, further comprising:
providing application guidance regarding network services in response to the signal.

73. The method of claim 68, wherein the receiving comprises intercepting an HTTP URL request sent between the user equipment and an information server.

74. The method of claim 68, wherein the network information comprises a physical resource block utilization.

75. The method of claim 68, further comprising:
monitoring, by the network, compliance with an application optimization suggestion in the network based information.

76. The method of claim 68, wherein
when the user equipment is connected to a first access network associated with a core network containing a first instance of an information server therein, the receiving comprises the first instance of the information server receiving the application-level signal from the user equipment; and
when the user equipment is connected to a second access network not associated with the core network, the receiving comprises a second instance of the information server receiving the application-level signal from the user equipment.

77. An apparatus, comprising:
at least one processor; and
at least one memory including computer program code,
wherein the at least one memory and the computer program code are configured to, with the at least one processor, cause the apparatus at least to
send, from a user equipment device or application server, an application level signal configured to identify a need for network based information to an information server;
receive the network based information based response in response to the signal; and
adapt a session with a second application server based on the network based information received from the information server.

78. An apparatus, comprising:
at least one processor; and
at least one memory including computer program code,
wherein the at least one memory and the computer program code are configured to, with the at least one processor, cause the apparatus at least to
receive, from a user equipment device or application server, an application level signal configured to identify a need for network information; and
provide the network based information in response to the application level signal.

79. A system, comprising:
a first apparatus comprising sending means for sending, from a user equipment device or application server, an application level signal configured to identify a need for network based information to an information server, receiving means for receiving the network based information based response in response to the signal, and adapting means for adapting a session with a second application server based on the network based information received from the information server; and
a second apparatus comprising receiving means for receiving, from the user equipment device or application server, the application level signal configured to identify a need for network information and providing means for providing the network based information in response to the application level signal.
